(19) United States
(12) Patent Application Publication
(10) Pub. No.: US 2026/0278510 A1
(43) Pub. Date: Sep. 17, 2026

(54) Artificial-Intelligence-Based Mapping of a Category Graph Data Structure

(71) Applicant: Blue Yonder Defense Solutions, LLC, Dallas, TX (US)

(72) Inventor: Ranjit Notani, Plano, TX (US)

(21) Appl. No.: 19/569,360

(22) Filed: Mar. 17, 2026

Related U.S. Application Data
(60) Provisional application No. 63/773,064, filed on Mar. 17, 2025.

(51) Int. Cl. G06Q 10/0635; G06F 16/901

(52) U.S. Cl. CPC G06Q 10/0635; G06F 16/9024

(57) ABSTRACT

A method includes generating a directed cyclic graph by determining a subset of categories associated with the primary entity. For each respective category in the subset of categories, determining whether the respective category is represented in the directed cyclic graph, adding the respective category to the directed cyclic graph as a node, and determining a respective subset of categories contained by the respective category. The method includes iterating through the respective subset of categories for each selected category of the respective subset of categories by, in response to a determination that the selected category is not represented in the directed cyclic graph, adding the selected category as a node and creating an edge from the respective category to the selected category. The method includes determining a set of relationships between a set of entities and the primary entity based on the directed cyclic graph.

### CROSS-REFERENCE TO RELATED APPLICATIONS

This application claims the benefit of U.S. Provisional Application No. 63/773,064 filed Mar. 17, 2025 (Attorney Docket No. 59708-4), the entire disclosure of which is incorporated by reference.

### FIELD

The present disclosure relates to data extraction and processing and, more particularly, to automated generation of entity relationship data structures from large language models.

### BACKGROUND

Modern goods are frequently complex and include many individually produced elements. A single good may include hundreds of elements, each of which may be provided by a different supplier. Each supplier in turn relies on a number of suppliers to provide materials, resulting in a complex supply chain including potentially tens of thousands of individual direct and indirect suppliers. Determining the complex directed graph of relationships and materials is impossible without computerized systems.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method includes generating a directed cyclic graph by receiving a primary entity. Generating the directed cyclic graph includes determining, using a set of models, a subset of categories associated with the primary entity from among a set of categories. Each category in the set of categories describes a set of items. Generating the directed cyclic graph includes, for each respective category in the subset of categories, determining whether the respective category is represented in the directed cyclic graph, in response to a determination that the respective category is not represented in the directed cyclic graph, adding the respective category to the directed cyclic graph as a node, determining, using the set of models, a respective subset of categories that is contained by the respective category, and iterating through the respective subset of categories. Iterating through the respective subset of categories for each selected category of the respective subset of categories includes determining whether the selected category is represented in the directed cyclic graph, in response to a determination that the selected category is not represented in the directed cyclic graph, adding the selected category to the directed cyclic graph as a node, and creating an edge in the directed cyclic graph from the respective category to the selected category. The method includes receiving data specifying a set of entities. The method includes determining, using the set of models, a set of relationships between the set of entities and the primary entity. Determining the set of relationships is based on the directed cyclic graph. The method includes generating a graphical view of the directed cyclic graph for presentation to a user.

In other features, the method includes receiving a data set that defines the set of categories. In other features, determining the set of relationships includes determining, using the set of models, a set of web domains associated with the set of entities. In other features, determining the set of relationships includes automatically acquiring domain data from the set of web domains. In other features, determining the set of relationships includes determining, for a secondary entity of the set of entities, a respective subset of categories of the set of categories associated with the secondary entity. The respective subset of categories is based on the domain data. In other features, determining the set of relationships includes defining a relationship between the secondary entity and the primary entity based on the directed cyclic graph and the respective subset of categories.

In other features, the secondary entity produces items for the primary entity. In other features, the method includes determining whether a respective web domain of the set of web domains exists for a tertiary entity. In other features, the method includes, in response to a determination that the respective web domain exists, automatically attempting to acquire corresponding domain data from the respective web domain. In other features, the method includes, in response to a determination that at least one criterion of a set of criteria has been met, determining, using the set of models, a substitute subset of data. The set of criteria includes a criterion that is met when the respective web domain does not exist, and a criterion that is met when the corresponding domain data cannot be automatically acquired from the respective web domain.

In other features, the domain data includes, for at least a portion of the set of web domains, data describing the set of entities, data describing items associated with the set of entities, and data describing locations associated with the set of entities. In other features, determining the set of relationships includes determining a set of locations associated with the secondary entity based on the domain data.

In other features, the method includes identifying a risk event. In other features, the method includes determining a likelihood that the risk event affects the secondary entity based on a first subset of categories of the set of categories associated with the secondary entity, a location associated with the risk event, and a location associated with the secondary entity. In other features, the method includes, in response to a determination that the likelihood of the risk event affecting the secondary entity is above a risk threshold, determining whether the risk event affects the primary entity.

In other features, determining whether the risk event affects the primary entity is based on whether the risk event affects items created for the primary entity. In other features, determining whether the risk event affects the secondary entity is based on at least one of a first activity associated with the secondary entity or a second activity associated with the secondary entity. The first activity is determined by the set of models using the location associated with the secondary entity as an input. The second activity is determined by the set of models using the domain data.

In other features, identifying the risk event includes receiving risk data describing the risk event. In other features, the risk data includes location data related to the risk event. In other features, the method includes updating a user interface to display the graphical view of the directed cyclic graph. In other features, the set of models includes a first machine learning model.

In other features, determining the respective subset of categories that is contained by the respective category includes inferring, using the large language model, a set of items contained by the respective category, inferring, using the large language model, a second subset of categories that correspond to the set of items, and assigning the second subset of categories as the respective subset of categories.

In other features, determining the respective subset of categories that is contained by the respective category includes generating a prompt. The prompt includes an identification of the respective category and instructions to identify a subset of identified categories, from the set of categories, that encompasses items contained by the respective category. In other features, determining the respective subset of categories that is contained by the respective category includes executing the large language model with the prompt as input, wherein the subset of identified categories is used as the respective subset of categories.

In other features, the set of categories includes a first category, a second category, and a third category. In other features, the first category and the second category include the third category. In other features, the set of categories includes a first category and a second category. The first category includes the second category, and the second category includes the first category.

A non-transitory computer-readable medium includes processor-executable instructions. The instructions include generating a directed cyclic graph by receiving a primary entity. Generating the directed cyclic graph includes determining, using a set of models, a subset of categories associated with the primary entity from among a set of categories. Each category in the set of categories describes a set of items. Generating the directed cyclic graph includes, for each respective category in the subset of categories, determining whether the respective category is represented in the directed cyclic graph, in response to a determination that the respective category is not represented in the directed cyclic graph, adding the respective category to the directed cyclic graph as a node, determining, using the set of models, a respective subset of categories that is contained by the respective category, and iterating through the respective subset of categories. Iterating through the respective subset of categories for each selected category of the respective subset of categories includes determining whether the selected category is represented in the directed cyclic graph, in response to a determination that the selected category is not represented in the directed cyclic graph, adding the selected category to the directed cyclic graph as a node, and creating an edge in the directed cyclic graph from the respective category to the selected category. The instructions include receiving data specifying a set of entities. The instructions include determining, using the set of models, a set of relationships between the set of entities and the primary entity. Determining the set of relationships is based on the directed cyclic graph. The instructions include generating a graphical view of the directed cyclic graph for presentation to a user.

A computerized system includes memory hardware configured to store instructions and processor hardware configured to execute the instructions. The instructions include generating a directed cyclic graph by receiving a primary entity. Generating the directed cyclic graph includes determining, using a set of models, a subset of categories associated with the primary entity from among a set of categories. Each category in the set of categories describes a set of items. Generating the directed cyclic graph includes, for each respective category in the subset of categories, determining whether the respective category is represented in the directed cyclic graph, in response to a determination that the respective category is not represented in the directed cyclic graph, adding the respective category to the directed cyclic graph as a node, determining, using the set of models, a respective subset of categories that is contained by the respective category, and iterating through the respective subset of categories. Iterating through the respective subset of categories for each selected category of the respective subset of categories includes determining whether the selected category is represented in the directed cyclic graph, in response to a determination that the selected category is not represented in the directed cyclic graph, adding the selected category to the directed cyclic graph as a node, and creating an edge in the directed cyclic graph from the respective category to the selected category. The instructions include receiving data specifying a set of entities. The instructions include determining, using the set of models, a set of relationships between the set of entities and the primary entity. Determining the set of relationships is based on the directed cyclic graph. The instructions include generating a graphical view of the directed cyclic graph for presentation to a user.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is an example graph diagram of item and entity relationships.

FIG. 2 is an example graph diagram of entity relationships based on first-party and third-party data.

FIG. 3 is an example method for determining a category-based directed graph.

FIG. 4 is an example method for determining a web domain for an entity and extracting data from the web domain.

FIG. 5 is an example method for determining a graph diagram of entity relationships and item relationships.

FIG. 6 is an example method for determining an event impact on the graph diagram of entity and item relationships based on item categories.

FIG. 7 is an example method for determining an event impact on the graph diagram of entity and item relationships based on location.

FIGS. 8A-8B are examples of a user interface for displaying a category graph.

FIG. 9 is an example of a cyclic category graph.

In the drawings, reference numbers may be reused to identify similar and/or identical elements.

### DETAILED DESCRIPTION

### Introduction

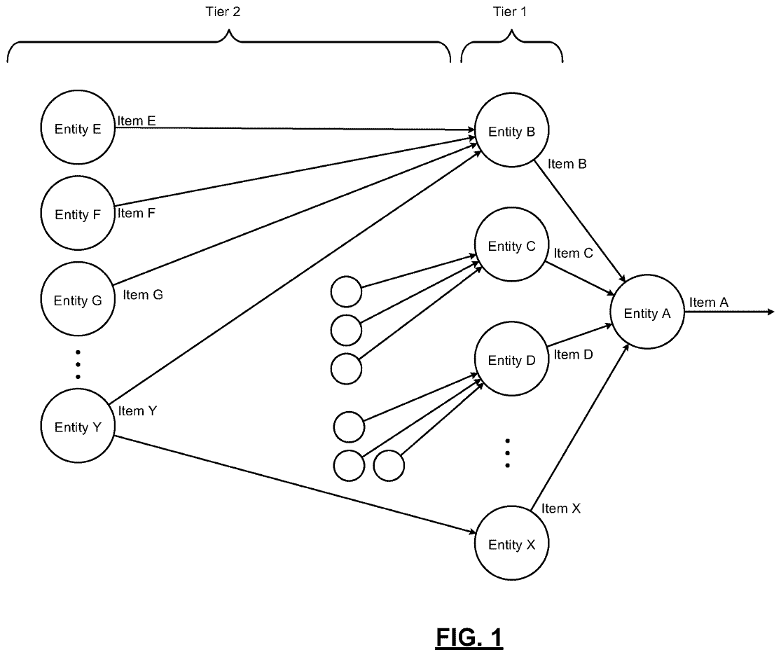

A modern supply chain frequently includes multiple tiers of suppliers. For example, as shown in FIG. 1, Entity A produces Item A and uses Entities B, C, and D-X to supply materials (Items B, C, and D-X) used to create Item A. In turn, Entities B, C, and D-X rely on other entities (such as Entities E, F, and G-Y) to supply materials for Items B-X. At each tier, the number of suppliers grows exponentially, which creates difficulty in determining the identities of suppliers (particularly as the relationship of the upstream supplier to Entity A becomes more distant) and estimating the risk associated with each individual supplier and the overall risk faced by Entity A.

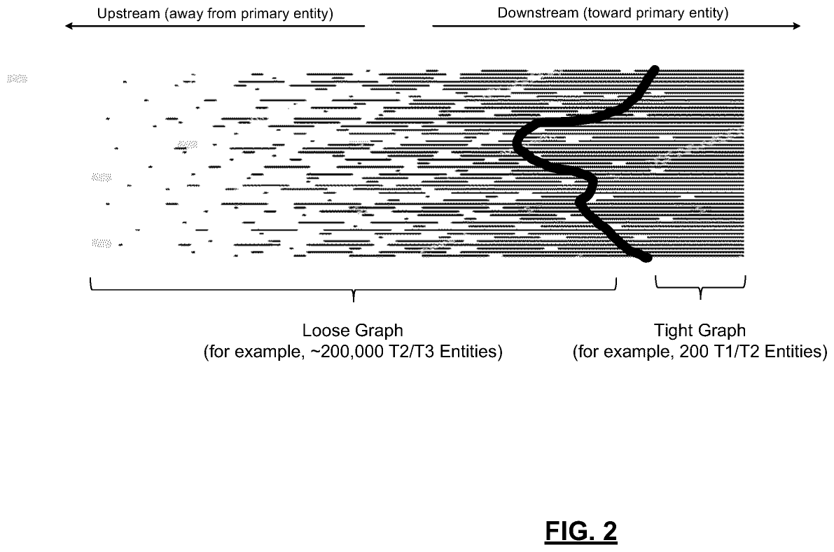

FIG. 2 is an example depiction of a primary entity and the various tiers of suppliers in the primary entity's supply chain. Representations of supply chain data (such as are depicted in FIG. 2) have many uses including determining risk as it propagates from lower-tier (upstream) entities to higher-tier (downstream) entities, reducing costs by providing insight into actual costs and informing negotiations, determining regulatory compliance (such as country of origin regulations), enabling quality control (such as pinpointing upstream entities that provide low-quality components), informing strategic planning, identifying innovation opportunities, identifying chain of custody, etc. While the present disclosure focuses on risk estimation and application, the methods and systems described are applicable to all of the aforementioned applications.

In order to comprehensively estimate risk, the entire supply chain must be identified. However, entities can usually only directly access supplier information a tier or two upstream in their supply chains. Supply chain data can be accessed generally by two methods. First, an entity (also known as an enterprise or an organization) can directly obtain supply chain data from its suppliers. This method produces the most reliable and detailed data. In FIG. 2, data obtained in this manner is described as the “tight graph.” The second way to obtain data is through third-party retrieval. In theory, this can be collected manually, but, due to the explosion in the number of entities and relationships as the graph is traversed upstream, algorithmic retrieval may be necessary. Indirectly collected supply-chain data is described as the “loose graph” in FIG. 2.

The depth of the tight graph (and the start of the loose graph) is neither fixed nor homogeneous. How much data an entity can directly collect is dependent on the strength of the relationship of the entity with its suppliers. However, even entities with strong relationships with their suppliers will eventually have an attenuated relationship with upstream suppliers and be unable to directly collect data. Algorithmic data curation relies on purchased data or open-source data and is often quite limited. For example, relationships between entities can sometimes be gathered through sources such as trade data, but additional information about the nature of the relationship (such as a bill of materials or a bill of distribution) is often unavailable.

When a risk event occurs, either in a particular geography or entity, the loose graph can be followed downstream to the primary entity (for example, Entity A in FIG. 1). Due to the coarse nature of an entity graph, this risk event may have a very large “blast radius”—that is, a large number of downstream entities are affected by the risk event. Due to the lack of fine-grained detail such as detailed Bills of Material (BOM) and Bills of Distribution (BOD), the calculated impact of a risk event is much broader than in reality. In other words, there are many false positives, which can overwhelm risk managers, supply chain managers, compliance managers, procurement managers, quality managers, etc. A key element of algorithmic curation of the loose graph is to reduce the blast radius of risk events (in other words, reduce false positives) and any other kind of downstream propagation (such as country of origin propagation).

### The Category BOM

The present disclosure discusses methods and systems to reduce the blast radius by creating a new type of BOM—a “Multi-Entity Category BOM”—which describes a Bill of Materials at a category level instead of at the item level. The Category BOM defines item-category-based relationships. The benefits of a Category BOM include storage efficiency (in other words, the category BOM is more compact in memory than a traditional BOM) and efficient querying (in other words, searching and analysis of the Category BOM requires less computation than a traditional BOM due to its simple category hierarchy).

A traditional BOM describes the components used to create an item. In turn, each component may have its own BOM. Collectively, the chain of related BOMs creates a BOM graph. Retrieving BOM information from third-parties (and therefore creating the loose BOM graph) is difficult if not impossible. A Category BOM can be used to overcome the difficulty of retrieving traditional BOM information and to filter risk event impacts in the loose graph. A Category BOM is not mutually exclusive with a traditional BOM. However, a traditional BOM is more detailed and is preferable to a Category BOM in scenarios where a traditional BOM is available.

A Category BOM is defined as the “component” relationship between categories of items rather than specific items. For example, a Category BOM describes a category of “cars” that is made up of “metals” and “electronic components” (amongst other categories) instead of a specific list of materials and components. Another difference between a Category BOM graph and a traditional BOM graph is that a traditional BOM graph is acyclic (because an item cannot contain itself) while a Category BOM can be cyclic. In other words, categories may have “has a” containment cycles. For example, Category A contains items from Category B, which in turn contains items from Category A.

### Computing the Category BOM

To compute the Category BOM, a categorization scheme is selected. In various embodiments, harmonized system codes (HS Codes) from the World Customs Organization (WCO) are used as categories, although other categories can be used if context is provided to the large language model to determine what types of items belong in which categories. HS Codes are widely known and easily understandable by large language models. While HS Codes are inherently hierarchical, the HS Code hierarchy represents an “is-a” relationship (for example, every X is also a Y), whereas a Category BOM represents a “containment” relationship (for example, X includes items that are made from items from category Y). As an example, a Category BOM using HS Codes might include codes 3006 (Pharmaceutical Goods) and 9021 (Orthopedic Appliances). With such broad categories, the Category BOM can easily be cyclic, as shown by the following: a first aid kit in HS Code 3006 includes an orthopedic splint in HS Code 9021, which includes a sterile Plaster of Paris bandage (HS Code 3006).

HS Codes have a hierarchical structure, with shorter codes describing broader categories and longer codes describing more specific categories:
Chapter (2-digit code)
   Heading (4-digit code)
      SubHeading (6-digit code).

In various embodiments, the Category BOM is created using the 4-digit Heading categories because the 4-digit Heading categories include a broad range of categories without being overly specific or overly generic. Using the categories, a 1-step Category BOM is computed. The LLM's understanding of HS Codes and items can be leveraged to extract the relationships between items and components without the need for additional or specialized training. For example, the list of all HS Codes may be stored into HSList, which can be represented as a two-level JSON structure. The 1-step Category BOM can be computed with the following LLM-based algorithm:

```
Foreach(HSCode parentHSCode in HSList)
  HSList potentialChildren = HSList − parentHSCode // Set
  subtraction
  actualChildren = LLMGetActualChildren(parentHSCode,
  potentialChildren)
  parentHSCode.children = actualChildren // JSON
```

The LLMGetActualChildren(parentHSCode, potentialChildren) function wraps a call to an LLM and creates a two-level structure that includes the parent HS Codes and their children. The list of parents and children is then converted into a cyclic graph by creating a directed edge from a parent to each of its children.

An example LLM prompt to generate a Category BOM includes: “compute a relationship between HS Codes that is analogous to a Bill of Material relationship except at a category level. For HS Code <parentHSCode> come up with a list of Children HS Codes such that there is a high likelihood that parent HS Code is made up of a child HS Code. Choose children from this list of HS Codes <potentialChildren>. Return as a two-level JSON structure with parent containing an array of highly likely child HS Codes.”

Computing the Categories that Each Entity Sells

After determining the Category BOM, and once a “main entity” (such as Entity A in FIG. 1) is known, the categories of items produced by each entity that are supplied directly or indirectly to the main entity are determined. In this context, the main entity (also called a “hub entity”) is at the head of the entity graph and produces the final output (labeled “Item A” in FIG. 1). Often, the main entity is performing the Category-BOM-based risk analysis to ensure uninterrupted production of the goods for the customers of the main entity.

Determining the categories of items produced by the various entities is performed by analyzing data from websites associated with the entity (for example, via an LLM) or directly querying an LLM's knowledge of an entity. This can be performed via an algorithm such as the following:

```
Foreach(entity in entities)
  If(entity has a domain name)
    Content = Visit web page and retrieve home page and
  likely product pages.
    EntityHSCodes = LLMGetLikelySoldHSCodesRAG(EntityName,
  Content, CandidateHSCodes)
  Else {
    EntityHSCodes =
  LLMGetLikelySoldHSCodesBasedOnLLMKnowledge(EntityName,
  EntityCountry, CandidateHSCodes)
  // detect errors
  If error
    Log Could not find HSCodes
  }
```

As another example, the two LLM queries below can be used to determine HS codes associated with an entity's products. The first LLM query relies on content from the web page of the entity. The second is based on the LLM's own internal knowledge.

LLMGetLikelySoldHSCodesRAG(EntityName, Content, CandidateHSCodes)
{
For company <EntityName> please come up with the likely list of
HSCodes that this company sells based on their website content
<content>. Please select from these candidate HS Codes
<CandidateHSCodes>.
}
LLMGetLikelySoldHSCodesBasedOnLLMKnowledge(EntityName,
EntityCountry, CandidateHSCodes)
{
For company <EntityName> in <EntityCountry> come up with the likely
list of HSCodes that this company sells}

### High-Level Steps in Category-BOM Impact-Focusing Algorithm

Once a Category BOM has been created, risk propagation may include several steps. First, the categories for the BOM are determined. In various embodiments, items are categorized using HS Codes. Determining the categories is performed once per industry (or even once globally). This step determines the relationship between products generally, not specific products or specific entities.

As noted above, a category BOM can be cyclic; therefore, it is possible for a connection (in other words, a path) to exist between item categories that is infinite in length. Note that the path itself is not cyclic, although the Category BOM, in general, is. In various embodiments, relationships of interest between categories are limited to paths below a threshold path length. For example, if Entity R is connected to Entity A by a path including ten or more entities, the path is not considered; meanwhile, a path between Entity A and Entity C that includes 4 entities is considered. In various embodiments, relationships between categories are limited to a shortest path between categories. In various embodiments, the shortest path is determined using an algorithm such as Dijkstra's algorithm.

Second, the relationship graph for a main entity (such as Entity A in FIG. 1) must be generated using both first and third-party information. In various embodiments, this step is performed algorithmically. In various embodiments, the relationship paths on the relationship graph are optimized based on whether a path is the shortest path and/or a path has a length beyond a threshold path length. In various embodiments, the first and second steps (determining the Category BOM graph and the relationship graph) are generally performed once to determine the relationships between the entities and products of the loose and tight BOM graph. In various embodiments, the Category BOM is organized by industry.

Third, the various categories produced by each entity in the relationship graph are determined. The third step is performed as needed, such as when a new main entity is enabled (such as Entity A), and its upstream vendors are determined. This process is discussed in additional detail below. Fourth, the list of boundary entities (in other words, entities located within the graph where the loose and tight graphs meet) are determined. In various embodiments, the categories (such as HS codes) for each item (known as boundary categories) produced by the boundary entities are determined.

Boundary entities are significant because they connect the tight and loose graphs. Within the tight graph, it is easier to determine risk because exact relationship data and an exact bill of materials are known. Within the loose graph, the category BOM and relationship graph are used to estimate relationships and risk. The boundary entities connect the Category BOM and the estimated risk determinations to the tight graph. In other words, the Category BOM is used to determine the likelihood of risk to boundary entities, which is then used to determine an estimate of risk to a main entity.

Determining which entities produce which item categories reduces false positives when determining whether a risk at one entity impacts another (such as whether an event at Entity R impacts Entity A). For example, if Entity R does not both (i) produce an item category that is eventually used by Entity A, and (ii) have a direct or indirect relationship with Entity A, the event at Entity R likely does not impact Entity A. In various embodiments, relationships are limited to a threshold path length and/or a shortest path. For example, Entity A has a connection on the relationship graph with Entity C because Entity C is used to transport items produced by Entity A. Therefore, a risk event that impacts Entity C can likely be ignored because it does not impact the production of items produced by Entity A, especially when there are alternative transportation entities.

Risk determinations can be determined based on whether there is both a relationship path and Category BOM path (sometimes a shortest path) between two entities. As an example, a risk event occurs at Entity R (denoted as source-Xentity). The source-categories (in other words, the categories of the items used and created) for Entity R are retrieved, and the category-BOM-based Category-Based-Impacted-Boundary is determined. For example, Category-Based-Impacted-Boundary can be computed by:

```
List CategoryBasedImpactedBoundaryEntities = [ ];
  for each Source-Category
    for each Boundary Entity
      for each Boundary-Category-in-Boundary-Entity
        if there is a (non-cyclic) path from Source-
  Category to Boundary-Category in the Category BOM (from Step
  1a), then add Boundary Entity to the List.
```

Next, Entity R's relationship to the tight/loose graph boundary (relationship-based-impacted-boundary) is determined, where the impacted boundary is the intersection of entities that are connected to Entity R via a shortest path (or path below a threshold length) on both the Category BOM graph and the relationship graph (impacted boundary=Category-Based-Impacted-Boundary INTERSECT XEntity-Relationship-Based-Impacted-Boundary). In other words, a boundary entity is determined to be impacted by the risk event at Entity R when there is both (i) a category connection between the impacted entity (Entity R) and the boundary entity, and (ii) a transaction relationship between the impacted entity and the boundary entity. A category connection is determined to exist between two entities when an entity is associated with an item category that is used (whether directly or through intermediate entities) by a second entity.

As another example, Entity A uses item category B to create item category A. Item category B is produced by Entity B and Entity R. Entity A only uses items produced by Entity R; therefore, there is no path between Entity A and Entity B. In various embodiments, the impacted categories can be determined based on the impacted boundary. In various embodiments, buffers (in other words, inventory at item-location) for items that belong to the categories impacted by the risk event are found.

### Category-Based Impact Analysis

As described above, the Category BOM can be used to narrow the blast radius for an impact of a risk event on an entity (for example, Entity A). In other words, the impact of the risk event can be more accurately estimated. The blast radius can be further narrowed by narrowing the impact to a particular category. For example, if an event is known to have created a shortage of graphics processing units (“GPUs”), the LLM can be prompted to determine the (HS Code) category for GPUs, and determine which entities in the graph use the category related to GPUs and therefore which entities will be impacted by the shortage.

### Geographic-Based Impact Analysis

In cases where there is a concentration of a particular product in a particular geographic area, then a geographic-based impact analysis can be performed. For example, Taiwan has a significant market share of critical items in HS Codes 8542 (Integrated Electronic Circuits) and 8541 (Semiconductor Devices). Thus, any kind of risk event in Taiwan propagates to 8542 and 8541.

In the example below, a JSON object indicates which HS codes are associated with Malaysia.

```
{
  “Malaysia”: {
    “8542”: “Electronic integrated circuits”, “2710”:
    “Petroleum oils, refined”,
    “4001”: “Natural rubber in primary forms”,
    “8473”: “Parts and accessories of computers”,
    “2603”: “Copper ores and concentrates”,
    “2606”: “Aluminum ores and concentrates”,
    “8541”: “Diodes, transistors, and similar semiconductor
    devices”,
    “8517”: “Telephones and other communication equipment”,
    “7408”: “Copper wire”,
    “7601”: “Aluminum, unwrought”
  }
}
```

The above example can be generated with an LLM prompt such as: “for <Malaysia>, what are the HS Codes (4-digit) where <Malaysia> has significant market share and can thus constitute supply chain risk if disrupted? Do not give any other information beyond a two-level JSON with the Country or State or City or Geography at the first level and the HS Codes with descriptions at the second level.”

In various embodiments, geographic-based impact analysis is performed at different geographic levels (such as country, state/region, or city). Different geographic levels may include varied results. The example below shows a JSON object indicating the various HS code categories associated with Texas, USA, which includes 2711 (Petroleum gases and other gaseous hydrocarbons) and similar categories.

```
{“Texas, USA”: {
    “2711”: “Petroleum gases and other gaseous hydrocarbons”,
    “2710”: “Petroleum oils, refined”,
    “2902”: “Cyclic hydrocarbons”,
    “2905”: “Acyclic alcohols”,
    “3901”: “Polymers of ethylene”,
    “3902”: “Polymers of propylene”,
    “8541”: “Diodes, transistors, and similar semiconductor
    devices”,
    “2909”: “Ethers and their derivatives”,
    “3907”: “Polyacetals, polycarbonates, and other
    polyesters”,
    “3811”: “Antiknock preparations and other additives for
    mineral oils”
  }
}
```

The example above can be generated via a prompt to an LLM like the following: “For <Texas, USA>, what are the HS Codes (4-digit) where <Texas> has significant market share and can thus constitute supply chain risk if disrupted. Do not give any other information beyond a two-level JSON with the Country or State or City or Geography at the first level and the HS Codes with descriptions at the second level.”

In contrast, Austin, Texas, USA includes 8542 (Electronic Integrated Circuits). This illustrates the importance of propagating risk at various levels of geographic-product aggregation. In various embodiments, the overall algorithm iterates over all countries, states, regions, and cities to compile a comprehensive geography-based category concentration risk at different levels of geographic granularity.

```
{“Austin, Texas, USA”: {
  “8542”: “Electronic integrated circuits”,
  “8471”: “Automatic data processing machines and units”,
  “8504”: “Electrical transformers, static converters, and
  inductors”,
  “8534”: “Printed circuits”,
  “8541”: “Diodes, transistors, and similar semiconductor
  devices”,
  “8517”: “Telephones and other communication equipment”,
  “8523”: “Discs, tapes, and other data storage devices”,
  “9030”: “Oscilloscopes, spectrum analyzers, and other
  measuring instruments”,
  “8501”: “Electric motors and generators”,
  “8486”: “Machines and apparatus for semiconductor
  manufacturing”
  }
}
```

### Market-Share-Based Category Concentration

Another level of geographic analysis is based on market share analysis for a product category. This market share can be relative to various levels. For example, one extraction could compute market share at the country level and one at the global level. This market share concentration can be taken into account when propagating the risk. The higher the market share, the higher the risk.

### Signal Strength Modulation

In the above method, a risk event (or any other kind of signal) is propagated along the acyclic path derived from the cyclic Category BOM graph towards the tight graph boundary. In various embodiments, a risk event has a “signal strength” of 1 at the source, which does not attenuate as it propagates through the Category BOM-derived path. However, this signal could be modulated to give more accurate impact results. In various embodiments, a high market share concentration, either for a geography or a country, could cause the initial signal strength to be increased over 1 in proportion to the market share.

In various embodiments, the signal strength decreases at each tier to reflect the fact that the farther away an event is from an entity (in terms of graph distance rather than geographic distance), the less impact it has on the entity. In various embodiments, the signal strength decreases based on HS Code or by geography. In various embodiments, the signal strength decreases more over large-scale distributors compared to manufacturers, as there are often alternatives to distributors (in other words, there is less sole-source risk). In various embodiments, the maximum tier travel distance of an event is capped at a threshold. In various embodiments, if there are multiple paths to the loose-tight boundary, the signal strength is that of the path with the strongest signal (in other words, signal-strength-based length compared to path-length).

### Flowcharts

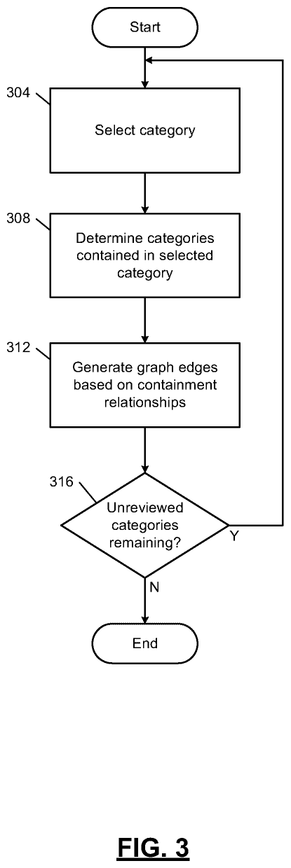

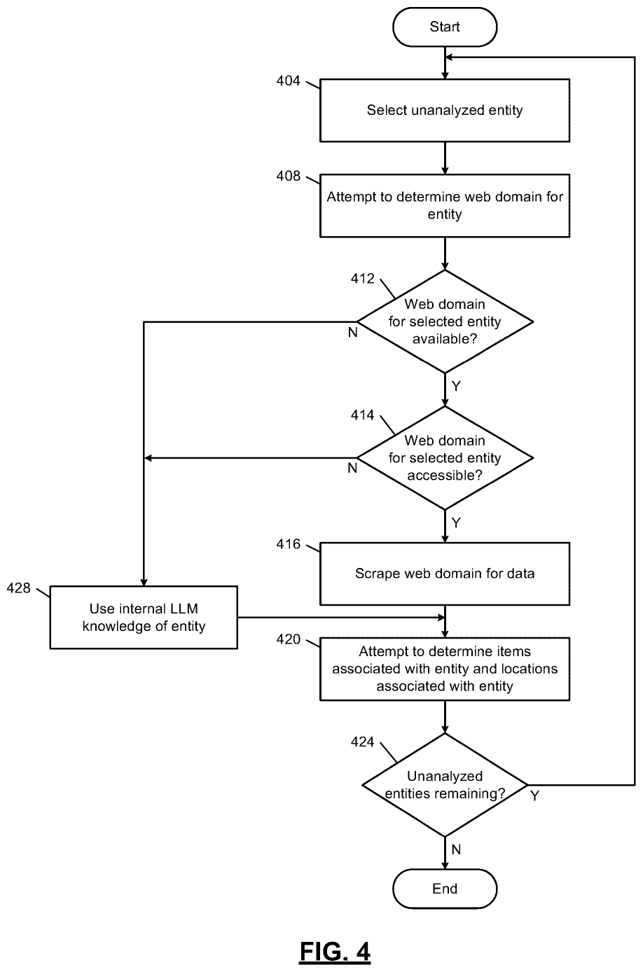

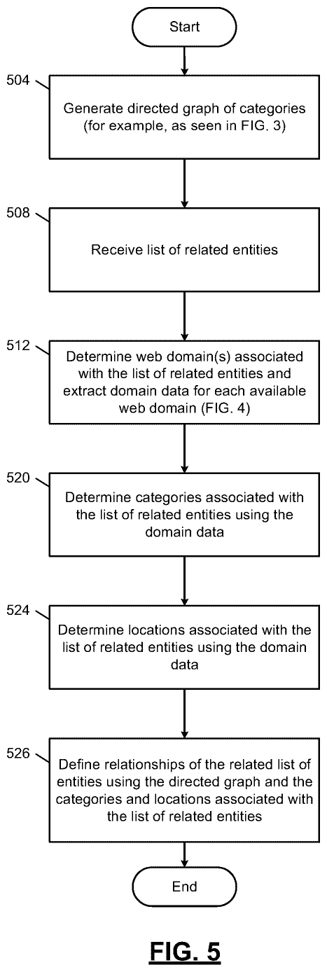

FIG. 3 is a flowchart of an example method of determining a category-based directed graph. At 304, control selects a category. In various embodiments, the selected category is selected based on categories related to a specific entity (for example, an entity of interest). In various embodiments, control selects a first category in a set of categories of interest. At 308, control determines categories contained by the selected category. At 312, control generates graph edges based on the containment relationships determined at 308. Next, control continues to 316 and determines if there are unreviewed categories remaining. If there are unreviewed categories, control returns to 304. If there are no unreviewed categories, control ends.

In various embodiments, the unreviewed categories are categories for which no relationship data is present in the category BOM. In various embodiments, unreviewed categories are categories for which control has not determined the categories contained by the category (for example, if category X is shown in the graph as contained by Y, but X contains no categories, X is unreviewed). In various embodiments, the set of categories analyzed for the category BOM is a predefined set of categories (for example, user-defined categories of interest or categories at a specific HS Code level, such as the 4-digit level).

FIG. 4 is an example method for extracting data for entities from web domains. At 404, control selects an analyzed entity (such as Entity A in FIG. 1). At 408, control attempts to determine a web domain associated with the selected entity. At 412, if no web domain is available, control transfers to 428. If a web domain is available, control transfers to 414. At 414, control determines whether the web domain of the selected entity is accessible. If the web domain is not accessible, control transfers to 428. If the web domain is accessible, control continues to 416. At 416, control scrapes the web domain for data. In various embodiments, the home page of the domain is scraped. In various embodiments, the home page plus direct links are scraped.

At 428, control uses the internal knowledge of the LLM regarding an entity (for example, an LLM trained using third-party sources such as online encyclopedias or news publications may have internal knowledge regarding an entity). At 420, control determines items and/or categories of items associated with the entity (such as Items A, B, and C) and locations associated with the entity. At 424, control determines whether there are unanalyzed entities remaining. If there are unanalyzed entities, control returns to 404. If there are no unanalyzed entities, control ends.

FIG. 5 is an example method for determining a graph diagram of entity relationships and item category relationships. At 504, control generates a directed cyclic graph of categories (as described in FIG. 3). At 508, control receives a list of related entities (for example, a primary entity and upstream entities based on first- and third-party data). At 512, control determines web domains associated with the entities and extracts domain data for each available web domain (as described in FIG. 4). At 520, control determines categories associated with the list of related entities using the domain data (described in FIG. 4). At 524, control determines locations associated with the entities using the domain data (as described in FIG. 4). At 526, control defines relationships of the entities using the directed cyclic graph of categories, the categories associated with the entities, and locations associated with the entities. For example, control determines (based on the directed cyclic graph) which categories of a first entity are contained in the categories of a second entity. In various embodiments, the locations associated with the entities are used when determining the propagation of risk from the first entity to the second entity.

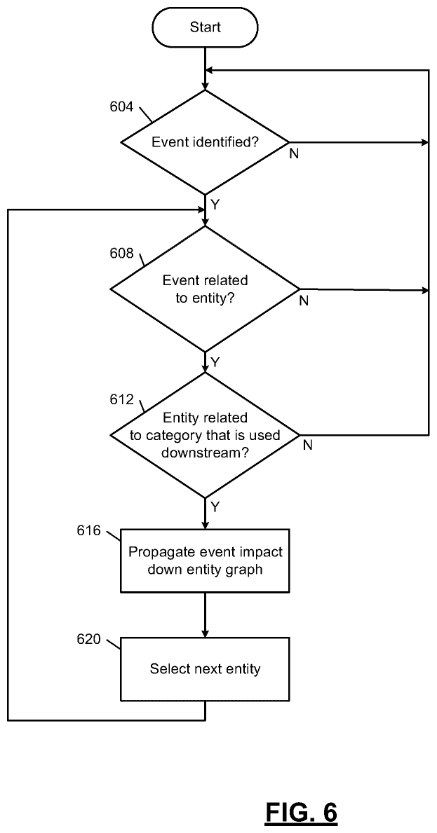

FIG. 6 is an example method for determining an event impact on the graph diagram of entity and item relationships based on item categories. Control starts at 604 and determines whether an event has been identified. If no event has been identified, control remains at 604. If an event has been identified, control transfers to 608. At 608, control determines whether the event impacts an entity (for example, an upstream entity). If the event does not impact the entity, control returns to 604. If the event impacts the entity, control transfers to 612. At 612, control determines whether the impacted entity is associated with a category that is used downstream (for example, control determines whether the impacted entity supplies the impacted category to the immediate upstream entity). If the entity is not related to a category that is used downstream, then control returns to 604. In other words, an entity may have upstream suppliers that do not relate to the downstream entities. If the entity is related to a category that is used downstream, control transfers to 616. At 616, control propagates the event impact downstream. At 620, control selects the next entity that requires analysis. In various embodiments, the next entity includes an entity directly impacted by the event. In various embodiments, the next entity includes an entity that is indirectly impacted by the event (such as a downstream entity).

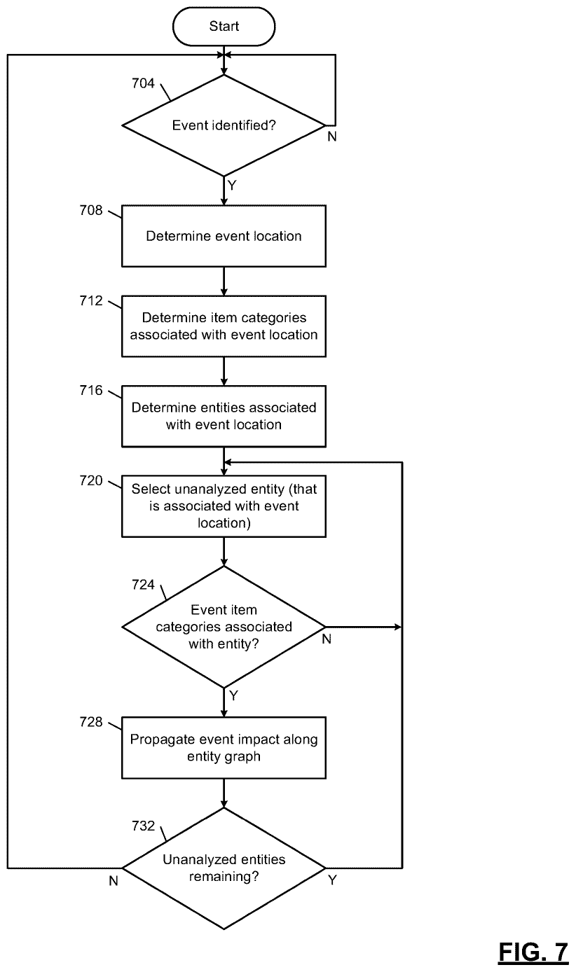

FIG. 7 is an example method for determining an event impact on the graph diagram of entity and item relationships based on location. Control begins at 704 and determines whether an event has been identified. If no event has been identified, control remains at 704. If an event has been identified, control continues to 708. At 708, control determines a location associated with the event. At 712, control determines item categories associated with the event location. At 716, control determines entities associated with the event location. At 720, control selects an unanalyzed entity that is associated with the event location. At 724, control determines whether the selected entity is associated with the location categories. If the selected entity is associated with the location categories, control continues to 728. If the selected entity is not associated with the location categories, control returns to 720. At 728, the event impact is propagated along (downstream) the entity graph. At 732, control determines whether there are unanalyzed entities remaining. If there are unanalyzed entities, control returns to 720. If there are no unanalyzed entities, control returns to 704.

### Example Category Graphs

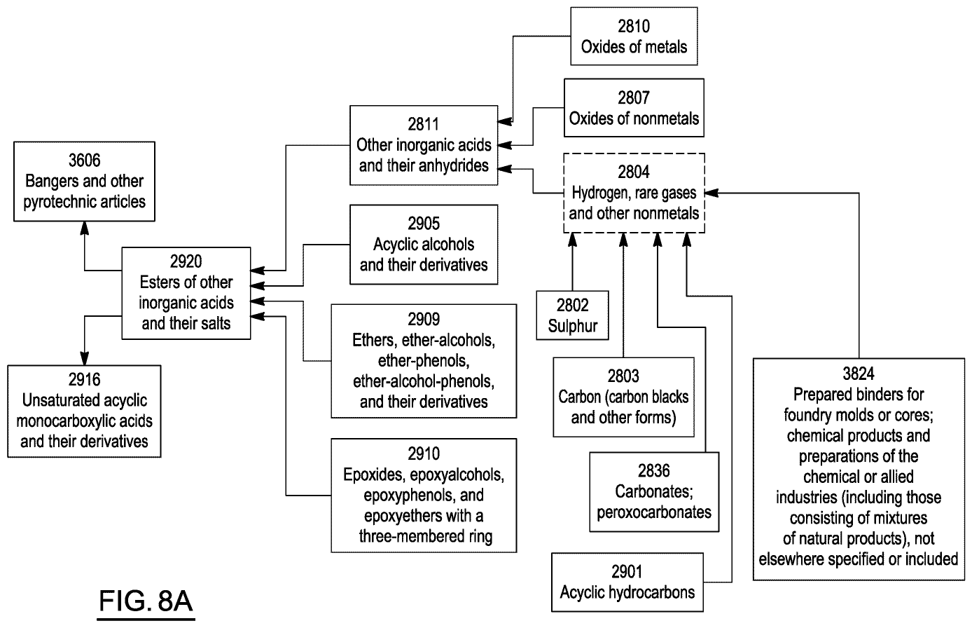

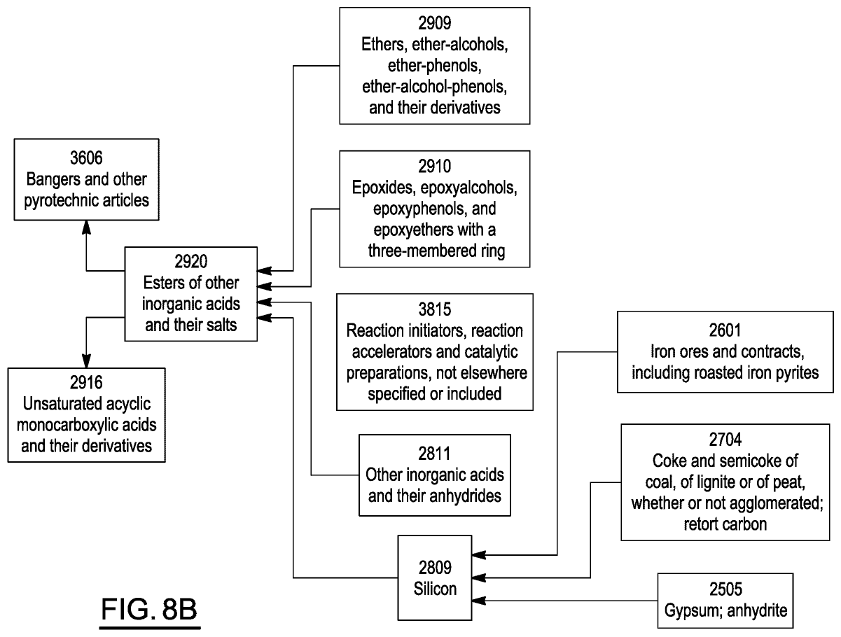

In various embodiments, the category graph is displayed in a user interface that can be used for risk analysis and/or reviewing category relationships. FIGS. 8A-8B are example user interfaces that include representations of the category graph. For example, FIG. 8A depicts various relationship types such as primary, supporting, associated, incidental, and residual. In various embodiments, the different relationship types are differentiated by various colors, formatting, or other means.

In FIGS. 8A and 8B, categories with relationships to category 2920 (esters of other inorganic acids and their salts) are displayed. Upstream categories include 2909 (ethers), 2910 (epoxides), 3815 (reaction initiators), 2811 (other inorganic acids), and 2809 (silicon). These categories often have upstream categories of their own, such as 2810 (oxides of metals), 2807 (oxides of nonmetals), and 2804 (hydrogen). Downstream categories include 3606 (bangers and other pyrotechnic articles) and 2916 (unsaturated acyclic monocarboxylic acids).

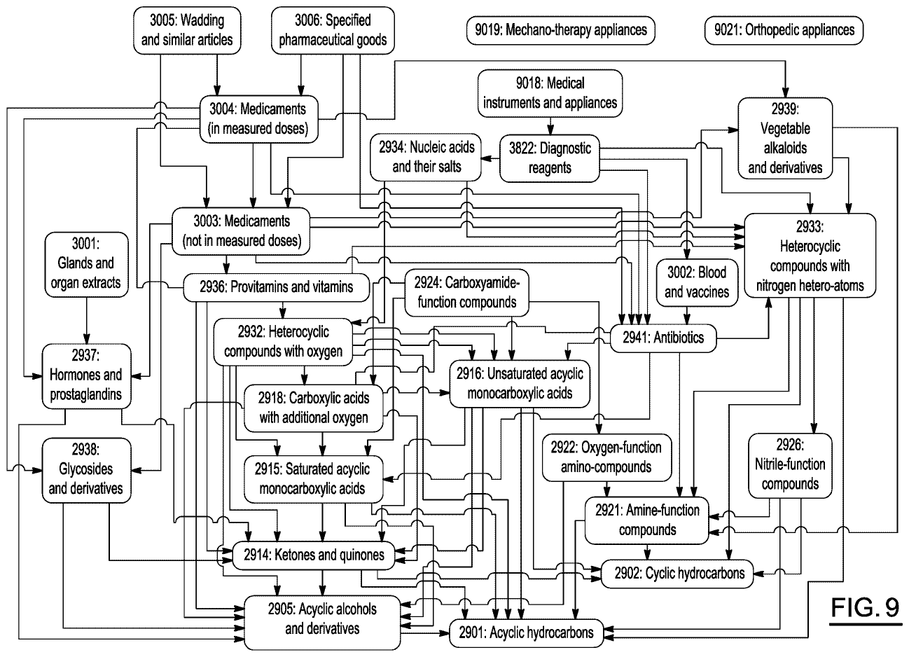

FIG. 9 is an example of a cyclic category graph. FIG. 9 depicts containment relationships for various categories. For example, category 2916 (unsaturated acyclic monocarboxylic acids) contains category 2901 (acyclic hydrocarbons).

### CONCLUSION

The above description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Numerical terms, such as “first,” “second,” and “third,” may be used in the disclosure and claims as unique labels: they are not used to imply a sequence or order unless the context clearly indicates otherwise. In other words, a “second” element could be relabeled as a “first” element without departing from the principles of the present disclosure. Further, the presence of a “second” element does not imply or require the presence of a “first” element. Similarly, the presence of a “first” element does not imply or require the presence of a “second” element.

Unless the context clearly indicates otherwise, the singular articles “a,” “an,” and “the” before a noun do not restrict the noun to a single instance. The verbs “comprise,” “include,” and “have” are inclusive and therefore specify the presence of elements without excluding the presence of one or more additional elements.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “coupled,” and “engaged.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

The term “set” generally means a grouping of one or more elements. The elements of a set do not necessarily need to have any characteristics in common or otherwise belong together. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR. The phrase “A, B, and/or C” should be construed in the same way as the phrase “at least one of A, B, and C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgments of, the information to element A.

In this application, including the definitions below, the term “module” can be replaced with the term “controller” or the term “circuit.” In this application, the term “controller” can be replaced with the term “module.” The term “module” may refer to, be part of, or include processor hardware (shared, dedicated, or group) that executes code coupled with memory hardware (shared, dedicated, or group) that stores code executed by the processor hardware.

The module may include or be connected to one or more interface circuits configured to couple the module to one or more networks. An interface circuit may include, for example, one or more of ports, transceivers, antennas, physical-layer (PHY) circuitry, and medium access control (MAC) circuitry. Examples of networks include a wireless personal area network (WPAN), a local area network (LAN), a wireless local area network (WLAN), and a wide area network (WAN), including private networks, public networks, the Internet, and other Internet Protocol (IP)-based networks. Examples of WLAN technologies include IEEE 802.11 (sometimes referred to as Wi-Fi) wireless local area networking technology. Examples of wired LAN technologies include IEEE 802.3 (sometimes referred to as Ethernet) networking technology. Examples of WPAN technologies include IEEE 802.15.4-based protocols, such as Zigbee- or Thread-based communications, and Bluetooth-based protocols, including Bluetooth Classic and Bluetooth Low Energy (BLE), as specified by the Bluetooth SIG. Examples of wireless wide area network (WWAN) technologies include cellular technologies, such as Long-Term Evolution (LTE) and 5G New Radio (5G NR).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a WAN such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term “code,” as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid-state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term “memory hardware” is a subset of the term “computer-readable medium.”

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PUP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD or DVD).

1. A method comprising:
generating a directed cyclic graph by:
receiving a primary entity,
determining, using a set of models, a subset of categories associated with the primary entity from among a set of categories, wherein each category in the set of categories describes a set of items, and
for each respective category in the subset of categories:
determining whether the respective category is represented in the directed cyclic graph,
in response to a determination that the respective category is not represented in the directed cyclic graph, adding the respective category to the directed cyclic graph as a node,
determining, using the set of models, a respective subset of categories that is contained by the respective category, and
iterating through the respective subset of categories by, for each selected category of the respective subset of categories:
determining whether the selected category is represented in the directed cyclic graph,
in response to a determination that the selected category is not represented in the directed cyclic graph, adding the selected category to the directed cyclic graph as a node, and
creating an edge in the directed cyclic graph from the respective category to the selected category;
receiving data specifying a set of entities;
determining, using the set of models, a set of relationships between the set of entities and the primary entity, wherein determining the set of relationships is based on the directed cyclic graph; and
generating a graphical view of the directed cyclic graph for presentation to a user.

2. The method of claim 1, further comprising receiving a data set that defines the set of categories.

3. The method of claim 1, wherein determining the set of relationships includes:
determining, using the set of models, a set of web domains associated with the set of entities;
automatically acquiring domain data from the set of web domains;
determining, for a secondary entity of the set of entities, a subset of categories of the set of categories that is associated with the secondary entity, wherein the subset of categories is determined based on the domain data; and
defining a relationship between the secondary entity and the primary entity based on the directed cyclic graph and the subset of categories.

4. The method of claim 3, wherein the secondary entity produces items for the primary entity.

5. The method of claim 3, further comprising:
determining whether a respective web domain of the set of web domains exists for a tertiary entity;
in response to a determination that the respective web domain exists, automatically attempting to acquire corresponding domain data from the respective web domain; and
in response to a determination that at least one criterion of a set of criteria has been met, determining, using the set of models, a substitute subset of data, wherein the set of criteria includes:
a criterion that is met when the respective web domain does not exist, and
a criterion that is met when the corresponding domain data cannot be automatically acquired from the respective web domain.

6. The method of claim 3, wherein the domain data includes, for at least a portion of the set of web domains:
data describing the set of entities;
data describing items associated with the set of entities; and
data describing locations associated with the set of entities.

7. The method of claim 6, wherein determining the set of relationships includes determining a set of locations associated with the secondary entity based on the domain data.

8. The method of claim 7, further comprising:
identifying a risk event;
determining a likelihood that the risk event affects the secondary entity based on:
a first subset of categories of the set of categories that is associated with the secondary entity,
a location associated with the risk event, and
a location associated with the secondary entity; and
in response to a determination that the likelihood of the risk event affecting the secondary entity is above a risk threshold, determining whether the risk event affects the primary entity.

9. The method of claim 8, wherein determining whether the risk event affects the primary entity is based on whether the risk event affects items created for the primary entity.

10. The method of claim 8, wherein determining whether the risk event affects the secondary entity is based on at least one of:
a first activity associated with the secondary entity, wherein the first activity is determined by the set of models using the location associated with the secondary entity as an input, or
a second activity associated with the secondary entity, wherein the second activity is determined by the set of models using the domain data.

11. The method of claim 8, wherein identifying the risk event includes receiving risk data describing the risk event.

12. The method of claim 11, wherein the risk data includes location data related to the risk event.

13. The method of claim 1, further comprising transforming a user interface to display information about the set of relationships in relation to the graphical view of the directed cyclic graph.

14. The method of claim 1, wherein the set of models includes a large language model.

15. The method of claim 14, wherein determining the respective subset of categories that is contained by the respective category includes:
inferring, using the large language model, a set of items contained by the respective category,
inferring, using the large language model, a second subset of categories that correspond to the set of items, and
assigning the second subset of categories as the respective subset of categories.

16. The method of claim 14, wherein determining the respective subset of categories that is contained by the respective category includes:
generating a prompt, wherein the prompt includes:
an identification of the respective category, and
instructions to identify a subset of identified categories, from the set of categories, that encompasses items contained by the respective category, and
executing the large language model with the prompt as input, wherein the subset of identified categories is used as the respective subset of categories.

17. The method of claim 1, wherein:
the set of categories includes a first category and a second category,
the first category includes the second category, and
the second category includes the first category.

18. A non-transitory computer-readable medium comprising processor-executable instructions, the processor-executable instructions including:
generating a directed cyclic graph by:
receiving a primary entity,
determining, using a set of models, a subset of categories associated with the primary entity from among a set of categories, wherein each category in the set of categories describes a set of items, and
for each respective category in the subset of categories:
determining whether the respective category is represented in the directed cyclic graph,
in response to a determination that the respective category is not represented in the directed cyclic graph, adding the respective category to the directed cyclic graph as a node,
determining, using the set of models, a respective subset of categories that is contained by the respective category, and
iterating through the respective subset of categories by, for each selected category of the respective subset of categories:
determining whether the selected category is represented in the directed cyclic graph,
in response to a determination that the selected category is not represented in the directed cyclic graph, adding the selected category to the directed cyclic graph as a node, and
creating an edge in the directed cyclic graph from the respective category to the selected category;
receiving data specifying a set of entities;
determining, using the set of models, a set of relationships between the set of entities and the primary entity, wherein determining the set of relationships is based on the directed cyclic graph; and
generating a graphical view of the directed cyclic graph for presentation to a user.

19. A computerized system comprising:
memory hardware configured to store instructions; and
processor hardware configured to execute the instructions, wherein the instructions include:
generating a directed cyclic graph by:
receiving a primary entity,
determining, using a set of models, a subset of categories associated with the primary entity from among a set of categories, wherein each category in the set of categories describes a set of items, and
for each respective category in the subset of categories:
determining whether the respective category is represented in the directed cyclic graph,
in response to a determination that the respective category is not represented in the directed cyclic graph, adding the respective category to the directed cyclic graph as a node,
determining, using the set of models, a respective subset of categories that is contained by the respective category, and
iterating through the respective subset of categories by, for each selected category of the respective subset of categories:
determining whether the selected category is represented in the directed cyclic graph,
in response to a determination that the selected category is not represented in the directed cyclic graph, adding the selected category to the directed cyclic graph as a node, and
creating an edge in the directed cyclic graph from the respective category to the selected category;
receiving data specifying a set of entities;
determining, using the set of models, a set of relationships between the set of entities and the primary entity, wherein determining the set of relationships is based on the directed cyclic graph; and
generating a graphical view of the directed cyclic graph for presentation to a user.
